(19) United States
(12) Patent Application Publication
(10) Pub. No.: US 2003/0209360 A1
(43) Pub. Date: Nov. 13, 2003

(54) Motor control harness with braided, monofilament sleeve

(76) Inventors: Gregory M. Levine, St. Louis, MO (US); Robert T. Back, Hazelwood, MO (US)

Correspondence Address: Joseph M. Rolnicki, Thompson Coburn LLP, Suite 3500, One US Bank Plaza, St. Louis, MO, 63101-9928, US

(21) Appl. No.: 10/142,292

(22) Filed: May 9, 2002

(51) Int. Cl. H01B 11/00

(52) U.S. Cl. 174/72 A

(57) ABSTRACT

A motor control harness that bundles together a plurality of electrical conductors extending a movable electric motor and a stationary control system of the motor includes a braided, monofilament sleeve that functions to bundle the plurality of electrical conductors together while avoiding stress concentrations and fraying and/or breaking of the wires of the electrical conductors resulting from the movement of the motor relative to the stationary control system during operation of the motor.

### BACKGROUND OF THE INVENTION

(1) Field of the Invention

The present invention pertains to a motor control or motor harness that bundles together a plurality of electrical conductors that extend between an electric appliance motor and a control system of the motor, where the electrical conductors are bundled together by a braided, monofilament sleeve. The sleeve functions to bundle the plurality of electrical conductors together while avoiding stress concentrations and fraying or breaking of the wires of the electrical conductors resulting from movement of the motor relative to the motor control system during operation of the motor.

(2) Description of the Related Art

In many home appliances that are powered by electric motors, the electric motor is mounted to a component of the appliance that will move relative to the enclosure of the appliance during operation of the motor. For example, in an electric clothes washer, the motor that powers the agitation and/or rotation of the drum of the washer is mounted to the internal structure of the clothes washer that supports the drum. On operation of the clothes washer, the motor agitates or rotates the drum at different speeds, depending on the mode of operation of the clothes washer. The movement of the drum by the motor also imparts movement to the motor.

Operation of the motor is controlled by an electronic control system contained in the appliance enclosure that is typically mounted to a stationary surface of the appliance enclosure. The motor control system communicates with the motor through a plurality of electrical conductors that extend between the control system and the motor. The conductors are typically bundled together to prevent loose conductors from becoming snared with any of the moving component parts of the appliance. The plurality of electrical conductors that extend from the stationary motor control system to the appliance motor are flexed and bent during operation of the motor, which moves relative to the motor control system. The flexing and bending of the electrical conductors has at times resulted in fraying and breaking of the wires of the conductors, and thus, a failure of the proper operation of the appliance motor.

In order to avoid the potential problem of fraying and breaking of the electrical conductor wiring extending between the stationary motor control system and the moving appliance motor, the prevailing thinking was to stiffen the bundle of electrical conductors. It was thought that stiffening the bundle of electrical conductors would minimize their movement and reduce the potential for the wiring fraying and breaking inside the insulation of the conductors.

FIG. 1 schematically illustrates a prior art wiring harness 12 extending between a stationary motor control system 14 and a movable appliance motor 16. The wiring harness 12 is comprised of a plurality of electrical conductors 18, with each conductor having one or more wires covered by insulation. Each of the electrical conductor 18 has a length between opposite first 22 and second 24 ends of the conductor 18. The conductors first ends 22 are secured to electric terminals (not shown) of the motor control system 14 and the conductor second ends 24 are secured to each other in a plug 26 that is inserted into a receptor 28 of the motor 16.

To stiffen the lengths of the electrical conductors 18, the bundle of conductors is wrapped by a stiff plastic wrap 32. The wrap 32 is a stiff band of plastic that is wound in a spiraling configuration to form a tube. The plastic spiral wrap 32 is wrapped around the bundle of conductors 18 from adjacent the first ends 22 of the conductors to adjacent the second ends 24 of the conductors as shown in FIG. 1. The function of the plastic spiral wrap 32 was to make the bundle of electrical conductors 18 stiffer to prevent flexing of the wires of the conductors and their potentially fraying and breaking. To further stiffen the wiring harness 12 of the prior art, electrical tape 34 was often wrapped around the bundle of electrical conductors 18 and around the opposite ends of the plastic spiral wrap 32 wrapped around the conductors. In addition, pull ties or wire ties 36 would often be wrapped around the conductors at the opposite ends of the spiral wrap 32 to further stiffen the bundle of conductors.

With the spiral wrap 32 wrapped around the electrical conductors 18, one end of the wrap adjacent the conductor first ends 22 was secured to a stationary surface 38 of the appliance by a metal eyelet and fastener 42 attached to the surface. The opposite end of the spiral wrap 32 adjacent the electrical conductor second ends 24 was secured by a metal eyelet and fastener 38 to the motor 16 of the appliance.

With the wiring harness 12 connected between the motor 16 and motor control system 14, and with the motor control system 14 mounted to a stationary surface 38 of the appliance as shown in FIG. 1, operation of the appliance motor 16 would cause the motor to move relative to the control system 14, and thereby cause the electrical conductors 18 of the wiring harness to flex and bend. However, it was observed that even after stiffening the bundle of electrical conductors 18 by wrapping the stiff plastic spiral wrap 32 around the conductors, the bending of the electrical conductors 18 caused by movement of the motor 16 would produce stress concentrations in the wiring of the electrical conductors 18 that would lead to their breaking and the resulting failure of the motor to properly operate. To further stiffen the wiring harness 12, a higher gauge of wire, for example, 400 strand wire was used for the electrical conductors 18 to further stiffen the harness. However, even the higher gauge of wire would often eventually fray and break due to the movement of the electrical conductors 18 resulting from the movement of the motor 16 in the appliance.

What is needed to overcome the disadvantages of the prior art wiring harness 12 discussed above is a wiring harness that provides the function of holding together the bundle of electrical conductors while avoiding stress concentrations in the wires of the electrical conductors that could lead to their fraying and breaking.

### SUMMARY OF THE INVENTION

The inventors of the wiring harness of the present invention have discovered that, in contrast to the conventional thinking of the prior art that the way to avoid fraying and breaking of wires in the wiring harness was to stiffen the bundle of electrical conductors of the harness with the plastic spiral wrap and/or with higher gauge wires to reduce the bending in the wires during motor operation, that bundling the electrical conductors in a flexible sleeve that allows the conductors to flex and move freely within the sleeve substantially reduces stress concentrations in the wires of the conductors and significantly reduces the potential for the wires fraying and/or breaking as a result of motor operation.

The flexible sleeve of the wiring harness of the invention is comprised of a plurality of filaments, preferably monofilaments, that are braided and/or woven together in a pattern to produce the flexible, tubular sleeve of the invention. The plurality of filaments extend along the entire length of the sleeve and the braided or woven pattern of the filaments enables the sleeve to expand or contract in response to compressing the opposite ends of the sleeve length or tensioning the opposite ends of the sleeve length, respectively. This enables the sleeve to be easily mounted on the bundle of electrical conductors of the wiring harness by compressing the opposite ends of the sleeve, expanding the sleeve to allow the motor plug and attached electrical conductors to be inserted through the expanded sleeve. Subsequent tensioning of the opposite ends of the sleeve contracts the sleeve around the plurality of electrical conductors, producing a trim and snug bundle of the electrical conductors. However, the braided or woven pattern of the sleeve filaments allows the sleeve to flex relative to the electrical conductors and allows the free flexing and relative movement between the electrical conductors within the sleeve which avoids producing any stress concentration in the wires of the conductors that was often the result of using the prior art stiff plastic spiral wrap. Even with the opposite ends of the braided sleeve length being attached to the appliance motor and to a stationary surface of the appliance, movement of the motor relative to the stationary surface would produce flexing of the sleeve and expanding and contracting of the sleeve girth which would allow the motor electrical conductors to move freely within the sleeve, avoiding stress concentrations in the wires of the conductors. The reduction in stress concentrations in the conductor wires through use of the sleeve of the invention also allows the use of lower gauge wires, for example, 105 strand wires as opposed to 400 strand wires of the prior art. This also results in a cost reduction in the manufacture of the wiring harness of the invention.

Thus, the braided monofilament sleeve of the motor control harness of the invention is easily assembled to the electrical conductors of the harness, reduces stress concentrations in the wires of the electrical conductors and allows the use of less expensive electrical conductors.

### BRIEF DESCRIPTIONS OF THE DRAWING FIGURES

Further features of the invention are revealed in the following detailed description of the preferred embodiment of the invention and in the drawing figures wherein:

FIG. 1 is a schematic illustration of the prior art wiring harness in a home appliance environment in which it is used;

FIG. 2 is an enlarged view of the prior art wiring harness of FIG. 1;

FIG. 3 is a view similar to that of FIG. 1, but showing the braided sleeve of the wiring harness of the invention, replacing the prior art wiring harness in the illustrative environment of FIG. 1;

FIG. 4 is an enlarged view of the wiring harness of the invention employing the braided filament sleeve of the invention; and

FIG. 5 is an enlarged partial view of the sleeve first end showing the braided groups of filaments of the sleeve.

### DETAILED DESCRIPTION OF A PREFERRED EMBODIMENT

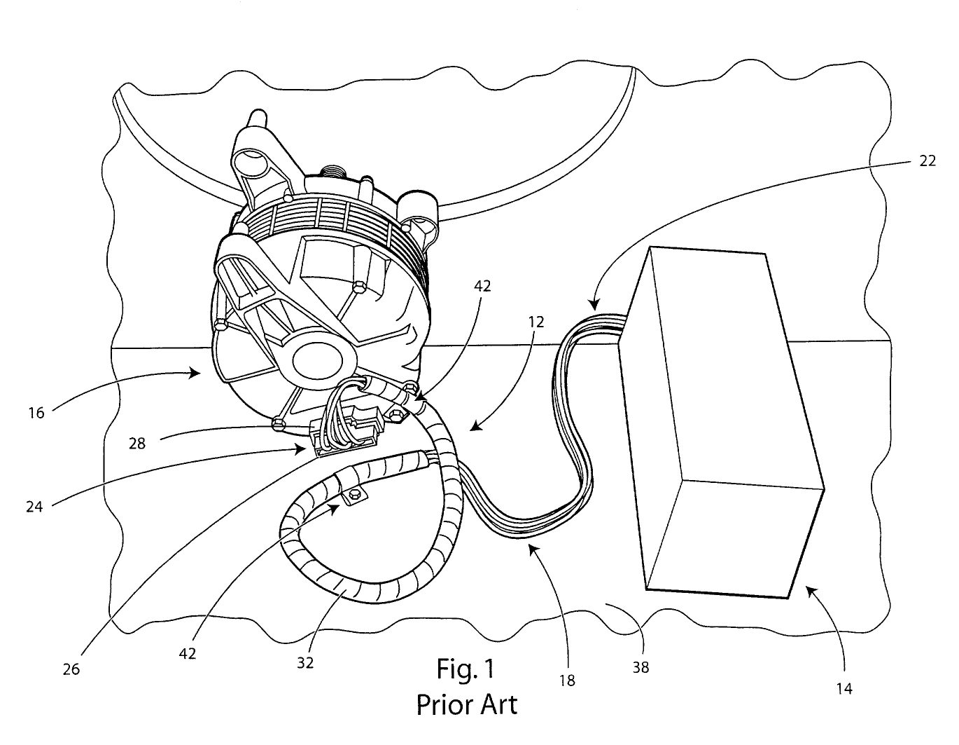

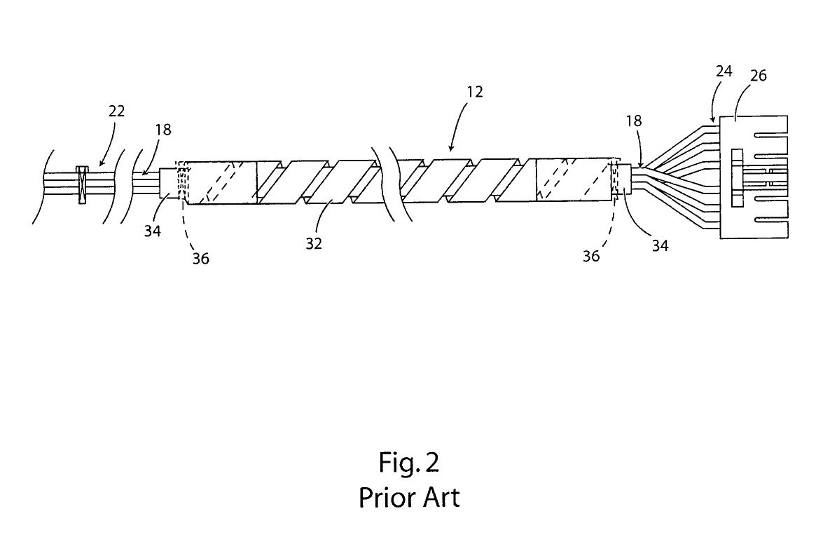

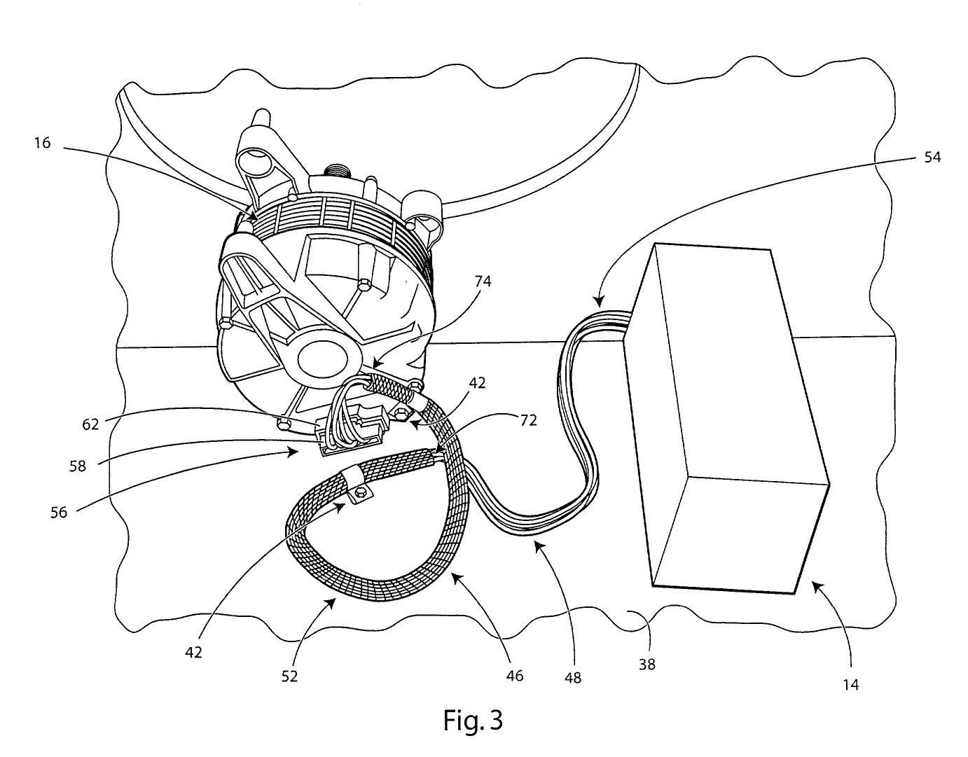

FIG. 3 shows basically the same illustrative environment of FIG. 1, but showing the wiring harness 46 of the invention replacing the wiring harness 12 of the prior art. The appliance motor 16 and the motor control system 14 secured to the stationary appliance's surface 38 are the same as those show in FIG. 1 and are therefore identified by their same reference numbers employed in describing the prior art home appliance environment of FIG. 1. Thus, the illustrative environment of FIG. 3 differs from that of FIG. 1 in only that the wiring harness 46 of the invention replaces the wiring harness 12 of the prior art. In addition, the electrical conductors 48 that make up a part of the inventive wiring harness 46 may be the same type of electrical conductors 18 of the prior art shown in FIG. 1, or may differ from the prior art electrical conductors by having a smaller gauge wire passing through the insulators of the conductors 48 as will be explained.

The wiring harness 46 of the invention is comprised of the plurality of electrical conductors 48 and the flexible sleeve 52 of the invention that bundles the conductors together. As in the prior art, the electrical conductors 48 each have a length with first ends 54 of the conductors secured to terminals (not shown) of the motor control system 14 and with opposite second ends 56 of the conductors secured together in a plug 58 that is inserted into a receptor 62 of the electric motor 16.

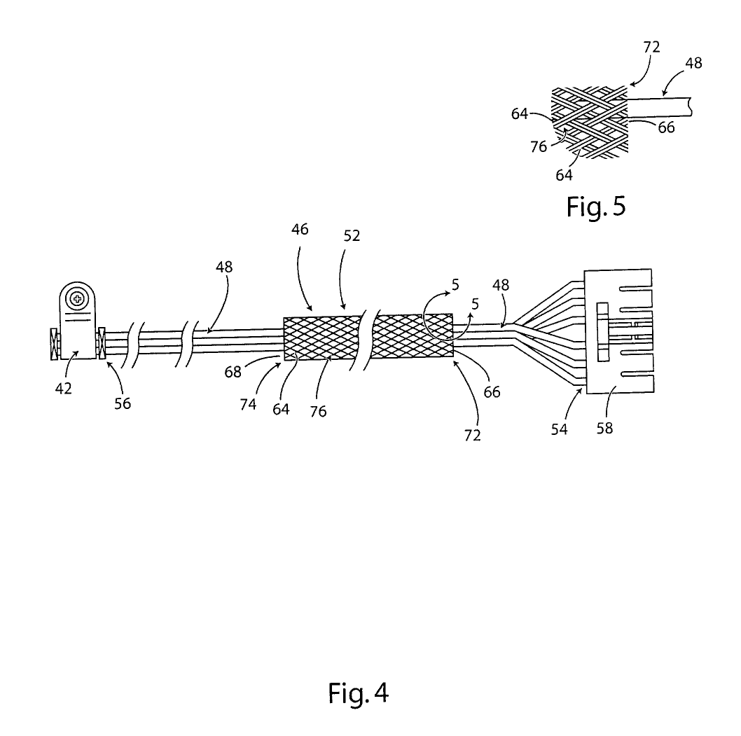

The flexible sleeve 52 of the wiring harness of the invention is comprised of a plurality of fibers or filaments 64, preferably nylon monofilaments, that are intertwined together to produce the flexible, tubular sleeve 52. In the preferred embodiment of the sleeve 52 the filaments are woven or braided together in a pattern as shown in FIG. 4 to produce the sleeve. Each of the filaments 64 has a length with opposite first 66 and second 68 ends. The lengths of the filaments 64 extend the entire length of the sleeve 52 so that the first ends 66 of the plurality of filaments define the sleeve first end 72 and the second ends 68 of the plurality of filaments define the sleeve second end 74. In one embodiment of the sleeve 52, individual filaments 64 are braided together to form the sleeve. However, in the preferred embodiment of the sleeve 52 small groups of filaments, for example three filaments, are positioned side by side with their first ends 66 coinciding and their second ends 68 coinciding. These small groups of filaments 66 are then braided together to form the length of the flexible sleeve 52. In variant embodiments of this sleeve structure, the small groups of filaments could be comprised of fewer than three filaments or more than three filaments. The filaments 64 of the sleeve are connected to each other only by the intertwining or braiding of the filaments, leaving the filaments 64 free to move independently and relative to each other. The braiding being the only interconnection of the sleeve filament 64 also allows the sleeve 52 to flex freely and move relative to the appliance electrical conductors 48 as will be explained.

As shown in FIGS. 3 and 4, the overall length of the sleeve 52 between its first 66 and second 68 ends is shorter than the length of the electrical conductors 48 bundled by the sleeve. It is only necessary that the sleeve length be sufficient to provide a trim and snug bundle of the electrical conductors. The plurality of filaments 64 extending along the length of the sleeve and the intertwined or braided pattern of the filaments enables the girth or parameter dimension around the tubular sleeve to expand or contract in response to compressing the opposite ends 66, 68 of the sleeve length toward each other or tensioning the opposite ends 66, 68 of the sleeve length away from each other, respectively. This enables the sleeve 52 to be easily mounted on the plurality of electrical conductors 48 to produce the wiring harness of the invention.

In mounting the sleeve 52 on the plurality of electrical conductors 48, the opposite first 66 and second 68 ends of the sleeve are compressed or moved toward each other. This causes the plurality of filaments 64 in the braided pattern of the sleeve, to alter the braided pattern from that shown in FIG. 4 where the filaments are oriented at a small angle relative to the length of the sleeve, to where the filaments are oriented at a larger angle relative to the compressed length of the sleeve. This movement of the filaments in the braided pattern of the sleeve causes the sleeve girth or perimeter dimension to increase, expanding the interior cross section of the tubular sleeve to the point where the motor plug 58 attached to the electrical conductors 48 can be easily passed through the interior of the expanded sleeve. Subsequent tensioning or pulling apart of the sleeve opposite ends 66, 68 causes the filaments to move back to their angular orientations shown in FIG. 4 and decreases the sleeve girth dimension, contracting the sleeve around the plurality of electrical conductors 48. This produces the trim and snug bundle of electrical conductors shown in FIG. 4.

The wiring harness formed with the sleeve 52 shown in FIG. 4 is mounted to the appliance motor 16 and the appliance stationary surface 38 in the same manner as the prior art wiring harness. An eyelet and fastener 42 secure the wiring harness 46 of the invention to the appliance stationary surface 38 adjacent the sleeve first end 66 and an eyelet and fastener 42 secure the opposite end of the wiring harness 46 to the electric motor 16 adjacent the sleeve second end 68. With the wiring harness 46 of the invention secured to the appliance surface 38 and motor 16 as shown in FIG. 3, the harness is subjected to the same bending movement produced by the movement of the motor 16 relative to the appliance surface 38 and the motor control system 14 as the prior art wiring harness 12. However, the braided or woven pattern of the sleeve filaments 64 allows the lengths of the filaments 64 and the sleeve 52 to flex relative to the electrical conductors 48 and allows the free flexing and relative movement between the electrical conductors within the sleeve which avoids producing any stress concentrations in the wires of the conductors that was often the result of using the prior art stiff plastic spiral wrap. Even with the opposite ends of the braided sleeve length 66, 68 being attached to the appliance stationary surface 38 and the appliance motor 16, movement of the motor relative to the stationary surface would produce flexing of the sleeve 52 and expanding and contracting of the sleeve girth which allows the motor electrical conductors 48 to move freely within the sleeve, avoiding stress concentrations in the wires of the conductors. The reduction of stress concentrations in the conductor wires through the use of the sleeve 52 of the invention also allows the use of lower gauge wires, for example, 105 strand wires as opposed to 400 strand wires of the prior art. This also results in a cost reduction in the manufacture of the wiring harness 46 of the invention.

Thus, the braided monofilament sleeve of the motor control harness 46 of the invention is easily assembled to the electrical conductors 48 of the harness, reduces stress concentrations in the wires of the electrical conductors and allows the use of less expensive electrical conductors.

Although the wiring harness of the invention has been described by reference to a specific embodiment, it should be understood that modifications and variations of the invention may be constructed without departing from the scope of the invention as defined by the following claims.

What is claimed is:

1. An electrical conduction harness comprising:
a plurality of electrical conductors, each conductor having a length with opposite first and second ends; and
a flexible sleeve around the plurality of conductors, the sleeve having a length with opposite first and second ends, the sleeve length being smaller than the lengths of the plurality of conductors and the sleeve being formed from a plurality of intertwined filaments.

2. The harness of claim 1, further comprising:
the plurality of intertwined filaments being braided.

3. The harness of claim 1, further comprising:
each of the filaments having a length that extends along the sleeve from the first end of the sleeve to the second end of the sleeve.

4. The harness of claim 1, further comprising:
the plurality of filaments being arranged in a plurality of groups with the filaments of each group being positioned with their lengths extending side by side, and the plurality of groups being braided together.

5. The harness of claim 1, further comprising:
the plurality of electrical conductors being free to move relative to each other in the sleeve.

6. The harness of claim 1, further comprising:
the plurality of intertwined filaments enable the sleeve to expand and contract around the plurality of electrical conductors.

7. The harness of claim 1, further comprising:
each filament being a nylon filament.

8. The harness of claim 1, further comprising:
each filament being a monofilament.

9. The harness of claim 1, further comprising:
each filament is free to move independently of the other filaments.

10. The harness of claim 1, further comprising:
each electrical conductor having at least one conductive wire and an electrical insulating layer over the wire.

11. The harness of claim 1, further comprising:
the first ends of the plurality of electrical conductors being secured together and the second ends of the plurality of electrical conductors being secured together.

12. The harness of claim 1, further comprising:
the first ends of the plurality of electrical conductors being connected to a stationary terminal and the second ends of the plurality of electrical conductors being connected to a movable terminal that moves relative to the stationary terminal and bends the electrical conductors and the sleeve.

13. The harness of claim 1, further comprising:
the sleeve having a girth and the intertwined filaments of the sleeve causing the sleeve girth to increase in response to the sleeve length being compressed and causing the sleeve girth to decrease in response to the sleeve length being tensioned.

14. An electrical conduction harness comprising:
a plurality of electrical conductors, each conductor having a length with opposite first and second ends; and,
a flexible sleeve around the plurality of conductors, the sleeve having a length with opposite first and second ends, the sleeve being formed from a plurality of intertwined filaments that enable the sleeve to expand and contract around the plurality of electrical conductors and enable the sleeve to move along the lengths of the electrical conductors.

15. The harness of claim 14, further comprising:
the plurality of intertwined filaments being woven together in a pattern around the sleeve.

16. The harness of claim 15, further comprising:
each filament being free to move independently of other filaments.

17. The harness of claim 14, further comprising:
each filament having a length with opposite first and second ends and the first ends of the filaments define the first end of the sleeve and the second ends of the filaments define the second end of the sleeve.

18. The harness of claim 14, further comprising:
the plurality of filaments being arranged in groups of filaments and the groups of filaments being braided together.

19. The harness of claim 14, further comprising:
the first ends of the plurality of electrical conductors being secured against movement relative to each other and the second ends of the plurality of electrical conductors being secured against movement relative to each other.

20. The harness of claim 14, further comprising:
the first ends of the plurality of electrical conductors being connected to a stationary terminal and the second ends of the plurality of electrical conductors being connected to a movable terminal that moves relative to the stationary terminal and bends the electrical conductors and the sleeve.

21. The harness of claim 14, further comprising:
the sleeve having a girth and the intertwined filaments of the sleeve causing the sleeve girth to increase in response to the sleeve length being compressed and causing the sleeve girth to decrease in response to the sleeve length being tensioned.
